(19) United States
(12) Patent Application Publication
(10) Pub. No.: US 2008/0038952 A1
(43) Pub. Date: Feb. 14, 2008

(54) Electrical connector with rotatable stuffer

(75) Inventors: Kuo-Chun Hsu, Tu-cheng (TW); Ti-Li Wei, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/890,866

(22) Filed: Aug. 8, 2007

(30) Foreign Application Priority Data
Aug. 8, 2006 (TW) 95213904

(51) Int. Cl. H01R 13/62

(52) U.S. Cl. 439/312

(57) ABSTRACT

An electrical connector for connecting a sheet-like connection member includes an insulating housing (1) with a receiving cavity (10) and a supporting portion (16) on a first end thereof, a plurality of terminals (2) arranged in the insulative housing (1) and a stuffer (3) comprising a tongue plate (31) insertable to the receiving cavity (10) and a pivot portion (32) defined at one end thereof. The pivot portion (32) is assembled on the supporting portion (16) of the insulative housing and the stuffer (3) rotates about the pivot portion (32).

### BACKGROUND OF THE INVENTION

1. Field of the invention

The present invention relates to an electrical connector, and more particular to an electrical connector for a sheet-like connection member such as a flexible printed circuit (FPC), a flexible flat cable and so forth. All of these cables and circuit hereafter will be generally referred to as “FPC” for simplification.

2. Description of Related Art

U.S. Pat. No. 6,971,901 discloses a conventional electrical connector adapted for connecting an FPC. The connector comprises an insulating housing having an insertion cavity into which the FPC is adapted to be inserted and a pair of guiding grooves respectively at two ends thereof. A stuffer includes a tongue plate and two plastic arms at two opposite ends. The tongue plate is pushed into and stuffers the insertion cavity with the plastic arms sliding along the guiding grooves. To ensure the stuffer to be retained in the housing, each of the arms has a projection to firmly contact with a corresponding projection on the guiding groove.

If the stuffer is needed to be drawn out after it is retained in the housing, user needs a large force exerted on it to overcome the friction between the tongue plate and FPC and said two projections. However, it is difficult to control said larger force, which may result in the plastic arms of the stuffer broken. Therefore, a new design is required.

### SUMMARY OF THE INVENTION

An object of the present invention is to provide an electrical connector with an anti-broken stuffer.

In order to achieve above-mentioned objects, an electrical connector comprises an insulative housing with a receiving cavity and a supporting portion on a first end thereof; a plurality of terminals arranged in the insulative housing; a stuffer comprising a tongue plate insertable to the receiving cavity and a pivot portion defined at one end thereof; wherein the pivot portion is assembled on the supporting portion of the insulative housing and the stuffer rotates about the pivot portion.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector in accordance with the present invention, wherein the stuffer is in a closed position;

FIG. 2 is an assembled perspective view of the electrical connector, wherein the stuffer is in an open position;

FIG. 3 is an exploded perspective view of the electrical connector;

FIG. 4 is another view of FIG. 3.

### DETAILED DESCRIPTION OF THE INVENTION

Reference will now be made to the drawing figures to describe the preferred embodiment of the present invention in detail.

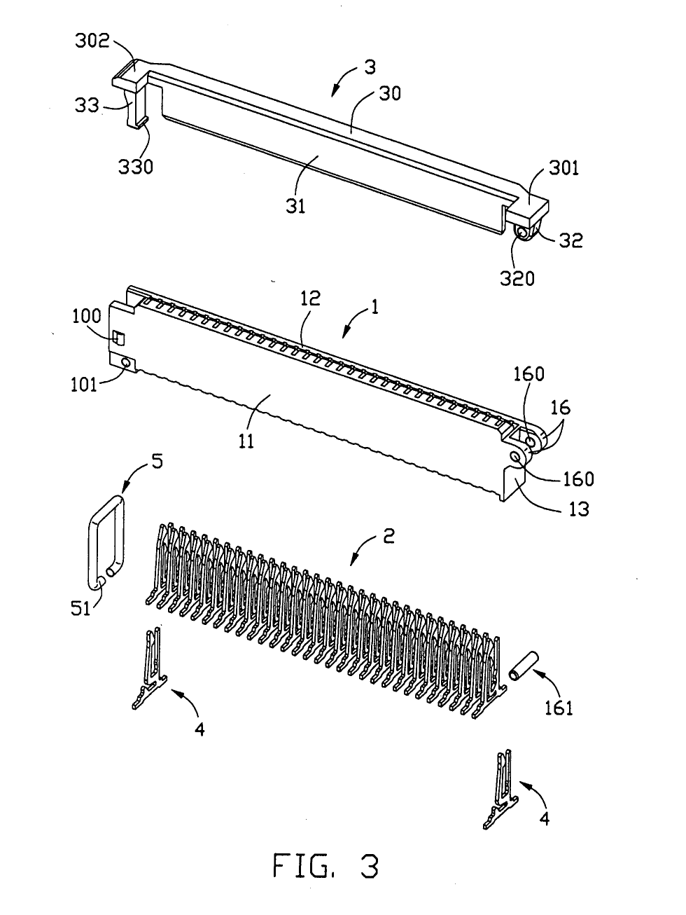

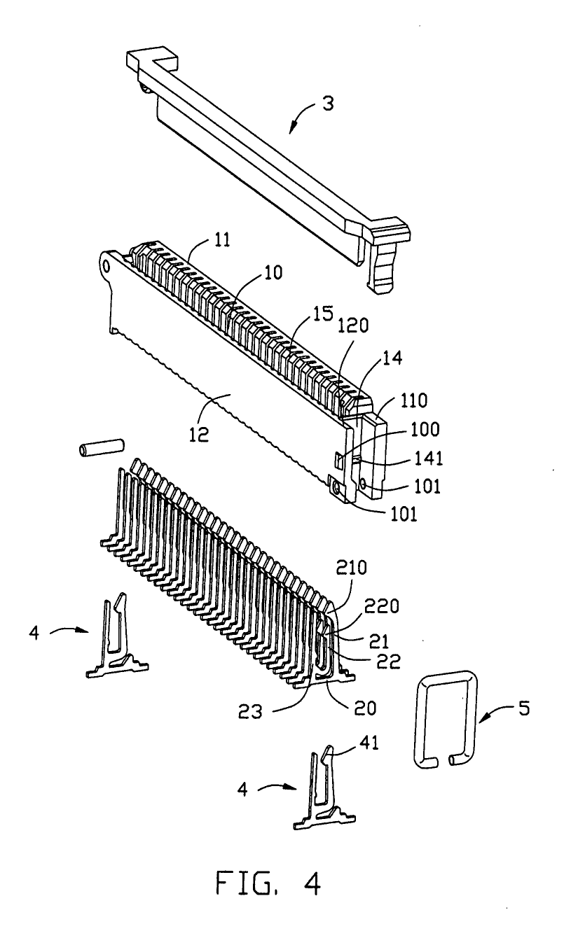

Referring to FIGS. 3 and 4, an electrical connector comprises an insulative housing 1, a plurality of conductive terminals 2, a stuffer 3, a pair of retaining terminals 4, a locking ring 5 and a shaft 161.

The housing 1 comprises a first wall 11, a second wall 12, a first and a second endwalls 13, 14 respectively connecting the first and second walls and a receiving cavity 10 defined therebetween. The first and the second walls 11, 12 respectively define a plurality of grooves 15 communicating with the receiving cavity 10. The conductive terminals 2 and the retaining terminals 4 are retained in the grooves 15.

Each conductive terminal 2 comprises a base section 20, a fixing arm 23 extending upwards from the base section 20, a first resilient arm 21 extending substantially parallel to the fixing arm 23, and a second resilient arm 22 branching from a root portion of the fixing arm 23. After the conductive terminal 2 mounted on the housing 1, tips on the fixing arm 23 fasten the terminal 2 to the groove 15 and the resilient arms 21, 22 extend forward with contact portions 210, 220 formed in the distal ends facing the receiving cavity 10, as best shown in FIG. 4.

The pair of retaining terminals 4 are used to retain the FPC. The structure of the retaining terminal 4 is similar to the conductive terminal 2, but without a second resilient arm. Each of the retaining terminals 4 is retained in the groove 15 near the endwalls 13, 14 with a locking portion 41 projecting to the receiving cavity 10.

Referring to FIG. 3, a pair of supporting portions 16 with a hole 160 project near the insertion open of the receiving cavity 10 from the first endwall 13. The first and second walls 11, 12 respectively extend outwards beyond the second endwall 14 to form a first and a second extending portions 110, 120 with a groove (not figured) therebetween. A projection 141 is formed in the middle of the groove. The first and second extending portions 110, 120 respectively define a hole 101 near the bottom of the groove and a retaining protrusion 100 above the hole 101 on the out surface.

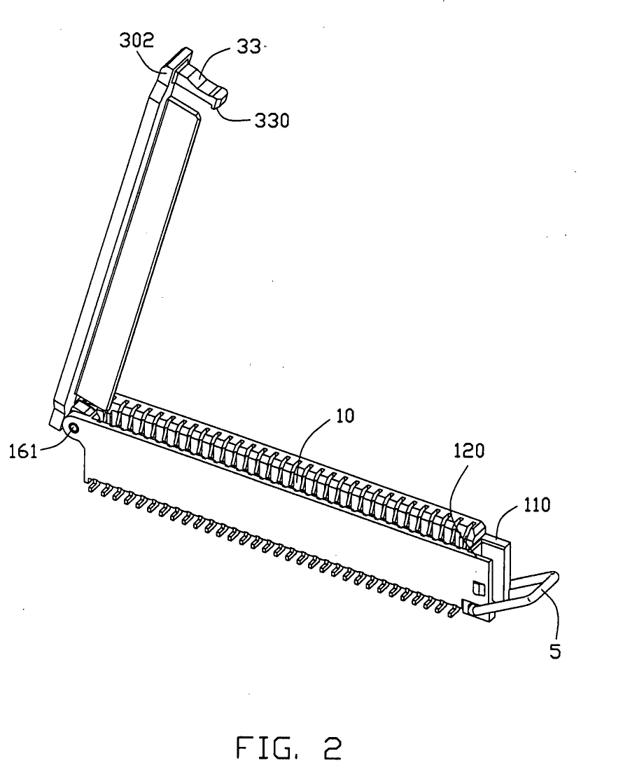

Referring to FIG. 3, the stuffer 3 has a rectangular base plate 30 with a first end portion 301 and a second end portion 302, and a tongue plate 31 vertically extending from the base plate 30. A pivot portion 32 with a pivoting hole 320 in the middle specially extends along the extending direction of the tongue plate 31 from the first end portion 301. The pivot portion 32 is pushed into the supporting portions 16, as best shown in FIG. 2, then the shaft 161 is inserted through the hole 160 and the pivot hole 320. Therefore, the first end portion 301 of the stuffer is assembled on the housing 1. Furthermore, the stuffer 3 defines a latching arm 33 with a hook portion 330 at its distal end, and the latching arm extends parallel to the tongue plate 31 from the second end portion 302.

Referring to FIGS. 2 and 3, the rectangle shaped locking ring 5 which is made by bending a metal shaft with two free ends 51 facing each other is retained in the housing 1 with two free ends 51 received in the hole 101.

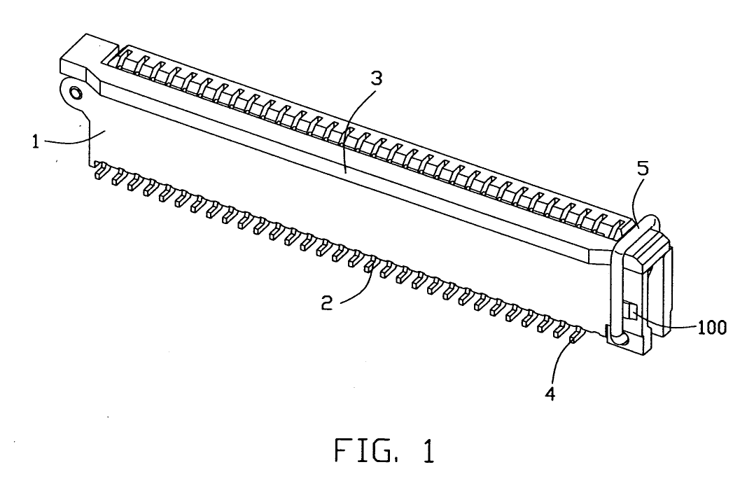

FIG. 2 shows an open position of the connector, wherein the stuffer is not inserted into the receiving cavity. Push the FPC(not shown) into the receiving cavity 10, and then rotate the stuffer 3 to the insertion open of the receiving cavity 10. When the tongue plate 31 is completely inserted into the receiving cavity 10, the hook portion 330 of the latching arm 33 hooks with the projection 141, as best shown in FIG.4. Finally, the locking ring 5 is rotated to the second end portion 302 until it surpasses the retaining protrusion 100, thus the stuffer 3 is in a closed position (as shown in FIG. 1) wherein the FPC contacts with the terminals. The retaining protrusion 100 can prevent the locking ring 5 releasing from the second end portion 302, and the locking ring 5 can fixedly retain the stuffer on the housing.

When the stuffer 3 needs to be pulled out, first rotate the locking ring 5 to go across the retaining protrusion 100, then draw the latching arm 33 out of the groove and rotate it to the open position. The whole process is very simple and the force exerted on the stuffer will not damage the arm.

The present invention is not limited to the electrical connector mentioned above. This disclosure is illustrative only, changes may be made in detail, especially in matter of shapes, size, and arrangement of parts within the principles of the invention.

What is claimed is:

1. An electrical connector comprising:
an insulative housing comprising a receiving cavity and a supporting portion on a first end thereof;
a plurality of terminals arranged in the insulative housing;
a stuffer comprising a tongue plate insertable to the receiving cavity and a pivot portion defined at one end thereof;
wherein the pivot portion is assembled on the supporting portion of the insulative housing and the stuffer rotates about the pivot portion.

2. The electrical connector as described in claim 1, wherein the supporting portion extends from the first end of the insulative housing and has a shaft to corporate with a hole defined on the supporting portion to hold the pivot portion.

3. The electrical connector as described in claim 1, wherein a locking ring is positioned on a second end opposite to the first end to retain the tongue plate in the receiving cavity fixedly.

4. The electrical connector as described in claim 3, wherein the locking ring is rectangular with two spaced free ends retained in a pair of insertion holes provided on the second end of the housing.

5. The electrical connector as described in claim 4, wherein the locking ring is rotatable about the insertion hole.

6. The electrical connector as described in claim 5, wherein the insulative housing defines a retaining protrusion at the second end thereof to prevent the locking ring from releasing from the stuffer.

7. The electrical connector as described in claim 6, wherein the retaining protrusion is above the insertion hole in which the locking ring is retained.

8. The electrical connector as described in claim 1, wherein the housing defines a guiding groove at a second end opposite to the first end thereof, the stuffer defines a latching arm to be locked in the guiding groove.

9. The electrical connector as described in claim 8, wherein a projection is formed in the guiding groove, the latching arm has a hook portion at the free end thereof to be locked with said projection.

10. An electrical connector assembly comprising:
an insulative housing defining an elongated slot, along a lengthwise direction, with at least one row of contacts located by one side of said slot;
a stuffer pivotally fastened to one end of said housing along said lengthwise direction, and including an abutment plate inserted into the elongated slot; and
a locking device located at the other end of said housing to lock said stuffer.

11. The electrical connector as claimed in claim 10, wherein a gap is defined in the slot after the stuffer is inserted into the slot for receiving an FPC (Flexible Printed Circuit).

12. The electrical connector as claimed in claim 10, wherein said locking device is a pivotal hook mounted on the other end of the housing.

13. The electrical connector as claimed in claim 10, wherein said locking device is a latch integrally formed on the stuffer.

14. An electrical connector assembly comprising:
an insulative housing defining an elongated slot, along a lengthwise direction, with at least one row of contacts located by one side of said slot;
a stuffer rotatably fastened to said housing, and including an abutment plate inserted into the elongated slot; and
a pivotal axis of said stuffer extends along a transverse direction perpendicular to said lengthwise direction.

15. The connector as claimed in claim 14, further including a locking device to retain the stuffer in position after said stuffer is rotated to a horizontal position and the abutment plate is received in the elongated slot.
